(19) United States
(12) Patent Application Publication
(10) Pub. No.: US 2004/0021370 A1
(43) Pub. Date: Feb. 5, 2004

(54) Electric system for a motor vehicle

(76) Inventors: Harald Eisenhardt, Rutesheim (DE); Rolf Falliano, Rudersberg (DE)

Correspondence Address: KENYON & KENYON, ONE BROADWAY, NEW YORK, NY, 10004, US

(21) Appl. No.: 10/333,603

(22) PCT Filed: May 29, 2001
(86) PCT No.: PCT/DE01/02034

(30) Foreign Application Priority Data
Jul. 19, 2000 (DE) 100 35 037.0

(51) Int. Cl. H02G 3/00

(52) U.S. Cl. 307/9.1

(57) ABSTRACT

A combined motor vehicle system has two vehicle networks having different supply voltages in which transmitting and receiving devices may exchange signals, regardless of their belonging to one or the other vehicle network, over a common bus conductor using uniform dominant and recessive data signals.

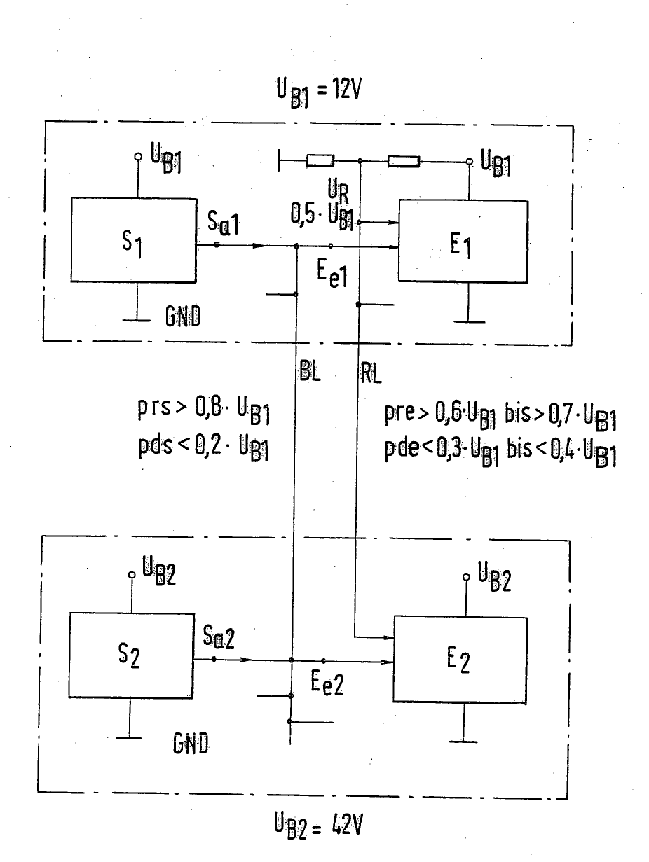

The present invention relates to an electrical system for a motor vehicle.

Conventional electrical systems are supplied with power from a vehicle network and include transmitting and receiving devices for data transmission, which is carried out using digital values. In passenger cars in particular, a 12 V vehicle network is used. However, for future passenger cars 42 V vehicle networks are also being planned, in which, for the same power consumption by the loads, the currents that occur are reduced due to the higher on-board voltage. Components which are supplied from a 12 V vehicle network and have a low power consumption can be manufactured more economically due to their mass production.

The object of the present invention is to provide an electrical system for a motor vehicle in which components with different supply voltages are able to exchange data via a bus conductor without need for separate bus systems or conversions.

This object is achieved according to the present invention by the fact that the system includes a vehicle network having a first supply voltage and a vehicle network having a second, higher supply voltage, as well as transmitting and receiving devices supplied by the first and second supply voltages, the transmitting outputs of the transmitting devices and the receiving inputs of the receiving devices being connected or connectable to a common bus conductor and exchanging digital data signals over this bus conductor, a common data reference potential derived from one of the two supply voltages having a common basic potential being assigned to all transmitting devices and receiving devices, and both data signals being representable by a data potential below the reference data potential and a data potential above the reference data potential.

In this combined system, the components are selectable in an optimum manner, and transmitting and receiving devices of both subsystems are able to exchange data via uniform digital data signals by using a common basic potential for both vehicle networks and a common reference data potential for data transmission.

According to one exemplary embodiment, the system includes transmitting and receiving devices for a 12 V supply voltage and transmitting and receiving devices for a 42 V supply voltage, which have a common ground potential, the reference data transmission potential being approximately one-half of the first supply voltage. The reference data potential may be derived, using a voltage divider, from the first, lower, supply voltage or from the second, higher, supply voltage.

Data transmission for LOW takes place according to a configuration having a dominant transmission level <0.2*U_{B1}, and a dominant reception level <0.3*U_{B1}, U_{B1} representing the first, lower, supply voltage U_{B1}, and the reference data potential being selected as one-half of the supply voltage.

For the HIGH data transmission, a recessive transmission level >0.8*U_{B1}, and a recessive reception level >0.7*U_{B1}, are used, U_{B1}, representing the first, lower, supply voltage U_{B1}, and the reference data potential being selected as one-half of the supply voltage.

Of course, the data signals for LOW and HIGH may also be reversed if the transmitting and receiving devices are configured accordingly.

A customary fixed reference value of 5 V, for example, which is known for electronic circuits, can also be selected for the reference data potential.

The present invention is explained in detail with reference to the exemplary embodiment illustrated as a block diagram in the drawing.

As the block diagram shows, a combined electrical system according to the present invention has two vehicle networks having different supply voltages: U_{B1} of 12 V, for example, and U_{B2} of 42 V, for example.

A plurality of transmitting devices S₁ and a plurality of receiving devices E₁ having transmitting outputs Sₐ₁ and receiving inputs Eₑ₁ are connected or connectable to a common bus conductor BL in the vehicle-network having the lower, first, supply voltage U_{B1}. The most diverse automobile components such as an air conditioner, a fan regulator, actuators, sensors, and the like may be used as transmitting and/or receiving devices. Depending on the configuration of the vehicle network, these devices are supplied from the vehicle network having supply voltage U_{B1} or from the vehicle network having the higher supply voltage U_{B2}, as shown by transmitting devices S₂ and receiving devices E₂. Transmitting outputs Sₐ₂ of transmitting devices S₂ and receiving inputs Eₑ₂ of receiving devices E₂ are connected or connectable to the common bus conductor BL. Apparatuses in the motor vehicle may also contain devices of both vehicle networks. The supply voltage of the devices determines their belonging to one or the other vehicle network. It is essential, however, that both vehicle networks have the same basic potential, which in the exemplary embodiment is the negative ground potential GND. Of course, the combination of two vehicle networks having different supply voltages may also be implemented with reverse potentials.

The type of data transmission over bus conductor BL takes place using digital data signals LOW, HIGH, “0” and “1” in different codings. As the coding of the information is not relevant to the present invention, it will not be explained in detail here. What is essential is the way the two data signals LOW and HIGH, i.e., “0” and “1” are represented on bus conductor BL.

For this purpose, a common reference data potential U_{R} is supplied to receiving devices E₁ and E₂ of both vehicle networks. In the exemplary embodiment, this reference data potential is derived via a voltage divider from the first, lower, supply voltage U_{B1} and supplied to receiving devices E₁ and E₂ via reference line RL. According to one embodiment, the reference data potential may be set at U_{B1/2}, it may be equal to 6 V, for example, and may vary according to the voltage fluctuations of supply voltage U_{B1}.

In order to have sufficient reliability in the data transmission, the levels for forming a dominant LOW, or “0”, data signal are defined as follows:

pds=dominant transmission level <0.2*U_{B1}

pde=dominant reception level <0.3 to 0.4*U_{B1}

Dominant transmission level pds applies to both transmitting devices S₁ and transmitting devices S₂. The same is true for receiving devices E₁ and E₂ regarding dominant reception level pde.

The following applies to recessive data signals HIGH or “1”:

prs=recessive transmission level >0.8*U_{B1}

pre=recessive reception level >0.6 to 0.7*U_{B1}

These levels apply similarly both to transmitting devices S₁ and S₂, as well as to receiving devices E₁ and E₂.

A fixed reference data potential U_{R} may also be defined. It should be approximately 50% of the minimum of the lower supply voltage U_{B1}. In a customary vehicle network having a 12 V supply voltage, the supply voltage fluctuates between 9 V and 16 V, so that a fixed reference data potential of +5 V is defined.

The positive data signals on common bus conductor BL are defined as follows and taken into consideration in dimensioning transmitting and receiving devices S₁, S₂ and E₁, E₂:

pds=dominant transmission level <0.2*U_{B1}

prs=recessive transmission level >0.8*U_{B1}

pde=dominant reception level <5 V

pre=recessive reception level >5 V

Thus the required difference between the given reception levels and reference data potential U_{R} may be observed using the transmission levels defined. The receiving part is advantageously provided with a hysteresis.

The assignment of levels to HIGH and LOW, i.e., “1” and “0” data signals may also be reversed.

What is claimed is:

1. An electrical system for a motor vehicle having a vehicle network having a first supply voltage (U_{B1}) and a vehicle network having a second, higher, supply voltage (U_{B2}), as well as transmitting devices (S₁, S₂) and receiving devices (E₁, E₂) supplied by the first and second supply voltages (U_{B1}, U_{B2}), the transmitting outputs (Sₛ₁, Sₛ₂) of the transmitting devices and the receiving inputs (Eₑ₁, Eₑ₂) of the receiving devices being connected or connectable to a common bus conductor (BL) and exchanging digital data signals (“0” AND “1”) over this bus conductor, a common data reference potential(U_{R}) derived from one of the two supply voltages (U_{B1}, U_{B2}) having a common basic potential (GND) being assigned to all transmitting devices (S₂, S₂) and receiving devices (E₁, E₂), and both data signals (“0” AND “1”) being representable by a data potential (pds, pde) below the reference data potential (U_{R}) and a data potential (prs, pre) above the reference data potential (U_{R}).

2. The electrical system as recited in claim 1,
wherein it includes transmitting and receiving devices (S₁, E₁) for a first 12 V supply voltage (U_{B1}) and transmitting and receiving devices (S₂, E₂) for a second 42 V supply voltage (U_{B2}), which have a common negative basic potential (GND), and data transmission is referred to a reference data potential (U_{R}) of approximately one-half of the first supply voltage (U_{B1}).

3. The electrical system as recited in claim 1 or 2,
wherein the reference data potential (U_{R}) is derived from the first, lower, supply voltage (U_{B1}) or the second, higher, supply voltage (U_{B2}) via a voltage divider.

4. The electrical system as recited in one of claims 1 through 4,
wherein the data signals (HIGH=“1”) are defined using a recessive transmission level (prs)>0.8*U_{B1} and a recessive reception level (pre)>0.7*U_{B1}), U_{B1} representing the first, lower, supply voltage (U_{B1}) and the reference data potential (U_{R}) being selected to be one half of the supply voltage (U_{B1/2}).

5. The electrical system as recited in one of claims 1 through 3,
wherein the data signals (LOW=“0”) are defined using a dominant transmission level (pds)<0.2*U_{B1} and a dominant reception level (pde)<0.3*U_{B1}, U_{B1} representing the first, lower supply voltage (U_{B1}) and the reference data potential (U_{R}) being selected to be one half of the supply voltage (U_{B1/2}).

6. The electrical system as recited in claims 4 and 5,
wherein the data signals (LOW, HIGH) having the dominant and recessive levels are reversed.

7. The electrical system as recited in claim 1,
wherein the reference data potential is set at approximately 50% of the lowest value (e.g., 9 V) of the lower supply voltage (U_{B1}) and is fixedly defined as 5 V, for example, and
the following transmission and reception levels are defined:
pds=dominant transmission level <0.2*U_{B1}
prs=recessive transmission level >0.8*U_{B1}
pde=dominant reception level <5 V
pre=recessive reception level >5 V.

8. The electrical system as recited in claim 7,
wherein the dominant and recessive reception levels are provided with a hysteresis.
